(19) United States
(12) Patent Application Publication
(10) Pub. No.: US 2025/0326939 A1
(43) Pub. Date: Oct. 23, 2025

(54) TREATED MEASUREMENT DEVICES AND METHODS OF REDUCING DEPOSITION OF HYDROCARBON CONTAMINANTS ON SURFACES THEREOF

(71) Applicant: ACULON, INC., SAN DIEGO, CA (US)

(72) Inventors: Eric L. Hanson, Carlsbad, CA (US); Eric L. Bruner, La Jolla, CA (US); Paul Lord, Houston, TX (US)

(21) Appl. No.: 19/186,194

(22) Filed: Apr. 22, 2025

Related U.S. Application Data
(60) Provisional application No. 63/636,986, filed on Apr. 22, 2024.

(51) Int. Cl. C09D 5/16; C09D 171/02; G01D 11/00

(52) U.S. Cl. CPC C09D 5/1662; C09D 171/02; G01D 11/00

(57) ABSTRACT

A treated measurement devices comprises an interior surface and a fluoropolymer coating layer applied thereto, demonstrating a hexadecane contact angle greater than 50 degrees. Methods of reducing deposition of hydrocarbon contaminants on a surface of a measurement device, comprises: contacting the surface with a coating composition comprising a fluoropolymer; forming a fluoropolymer coating layer demonstrating a hexadecane contact angle greater than 50 degrees on the surface; and contacting a fluid containing the hydrocarbon contaminants with the fluoropolymer coating layer. An alternative method comprises: contacting the surface either directly, or through an intermediate organometallic layer, with a fluorinated material in a diluent; forming a self-assembled monolayer on the surface; contacting the self-assembled monolayer with a coating composition comprising a fluoropolymer; forming a fluoropolymer coating layer on the self-assembled monolayer; and contacting a fluid containing the hydrocarbon contaminants with the fluoropolymer coating layer.

### RELATED APPLICATIONS

The present application claims the benefit of U.S. Patent Application Ser. No. 63/636,986, filed Apr. 22, 2024 which application is incorporated herein by references in its entirety.

### FIELD OF THE INVENTION

The present invention relates to treated measurement devices and methods of reducing deposition of hydrocarbon contaminants on surfaces of a measurement device.

### BACKGROUND OF THE INVENTION

A vast variety of fluids having a myriad of compositions are used in, and produced by, the oil and gas industry. The fluids are stored in and transported through heavy industrial equipment. A common problem with surfaces on such equipment is that due to exposure to the fluids, there is a tendency for surfaces to become fouled by deposition of insoluble hydrocarbon contaminants, such as paraffinic and asphaltene compounds, as they precipitate from the fluid stream. Excessive buildup can lead to reductions in flow rates, requiring higher pumping rates (and therefore more energy use). Moreover, devices that are critical to measure flow rates, such as electromagnetic flowmeters, coriolis flowmeters, etc., are particularly affected by the buildup of asphaltene and paraffinic deposits.

The use of self-assembled perfluorocarbon monolayers is well established as a known method for preparing metal equipment surfaces resistant to paraffin and asphaltene buildup. However, not all surfaces of the equipment, in particular, measurement devices, are metal; in some cases, it is necessary to use polymers such as PTFE, PEEK, etc., in the fluidic path, and they readily become contaminated with paraffin, asphaltene, and other hydrocarbon deposits.

It would be desirable to provide novel, surface-treated, measurement devices that resist deposition of a hydrocarbon contaminant on their component surfaces.

### SUMMARY OF THE INVENTION

The present invention is directed to treated measurement devices comprising:
a) an interior surface; and
b) a fluoropolymer coating layer coupled to the interior surface, wherein the fluoropolymer coating layer demonstrates a hexadecane contact angle greater than 50 degrees, thereby reducing deposition of hydrocarbon contaminants on the treated measurement device.

The present invention is further directed to methods of reducing deposition of hydrocarbon contaminants on a surface of a measurement device. An exemplary method comprises:
(a) contacting the surface with a coating composition comprising a fluoropolymer;
(b) forming a fluoropolymer coating layer on the surface; and
(c) contacting a fluid containing the hydrocarbon contaminants with the fluoropolymer coating layer on the measurement device; wherein the fluoropolymer coating layer demonstrates a hexadecane contact angle greater than 50 degrees.

An alternative method, particularly suited for metal surfaces, comprises:
(a) contacting the surface either directly, or through an intermediate organometallic layer, with a fluorinated material in a diluent, wherein the fluorinated material either: (a) has the following structure (1):

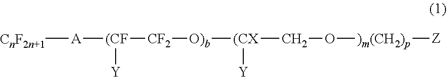

wherein A is an oxygen radical or a chemical bond; n is 1 to 20; Y is H, F, CₙH₂ₙ₊₁ or CnF₂ₙ₊₁; X is H or F; b is at least 1, m is 0 to 50, p is 1 to 20, and Z is an acid group or an acid derivative; or
(b) comprises a phosphonic acid functional compound, the phosphonic acid functional compound in turn comprising a moiety R_{F}, wherein R_{F} comprises any of the following structures:

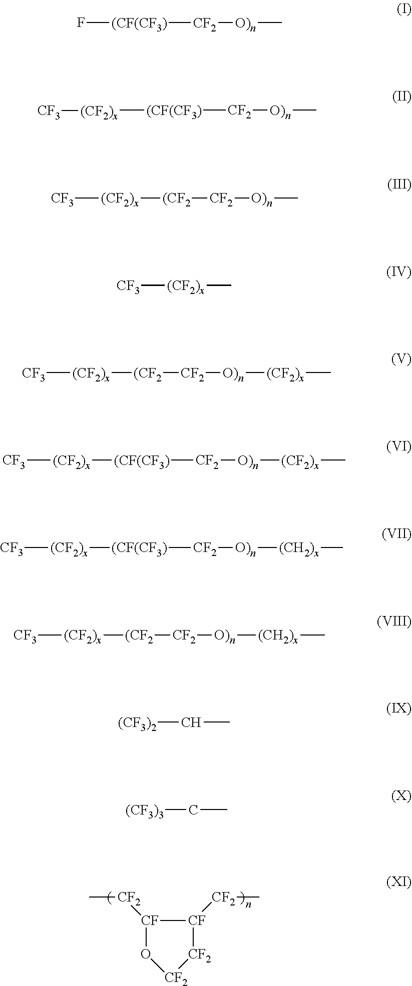

wherein n and x in each of structures (I) through (VIII) and (XI) are independently from 1 to 100, or 1 to 75, or 1 to 50, or 1 to 25, or 10 to 100, or 10 to 75, or 10 to 50, or 10 to 25;
(b) forming a self-assembled monolayer on the surface;
(c) contacting the self-assembled monolayer with a coating composition comprising a fluoropolymer, wherein the fluoropolymer comprises a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane;
(d) forming a fluoropolymer coating layer on the self-assembled monolayer; and
(e) contacting a fluid containing the hydrocarbon contaminants with the fluoropolymer coating layer on the measurement device; wherein the fluoropolymer coating layer demonstrates a hexadecane contact angle greater than 50 degrees.

These and other advantages of the present invention will be clarified in the following description of the present invention taken together with the attached figures in which like reference numerals represent like elements throughout.

### BRIEF DESCRIPTION OF THE DRAWINGS

FIG. 1 is a schematic cross-sectional view of an exemplary treated measurement device of the present invention.

FIG. 2 is a schematic cross-sectional view of a portion of a treated measurement device of the present invention.

FIG. 3 is a schematic cross-sectional view of a portion of a treated measurement device of the present invention that includes a self-assembled monolayer.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

As used herein, “formed from” denotes open, e. g., “comprising,” claim language. As such, it is intended that a composition “formed from” a list of recited components be a composition comprising at least these recited components, and can further comprise other, non-recited components, during the composition's formation.

The treated measurement devices 10 may comprise, for example, a Coriolis flow meter, venturi flow meter, magnetic flow meter, ultrasonic flow meter, float sensor, pressure gauge, positive displacement meter, level sensor, system property measurement transmitter, optical window, optical sensor, densitometer, laser-based sensing device, refractometer, viscometer, or a sensor that measures absorbance or transmittance of light.

The interior surface 202 being treated may comprise stainless steel; austenitic stainless steel; nitinol; nickel-chromium alloy and nickel-chromium-molybdenum alloy, such as Hastelloy B and Hastelloy C available from American Elements; nickel; titanium; tantalum; platinum-iridium alloy; tungsten carbide alloy; zirconium; polytetrafluoroethylene (PTFE); polyether ether ketone (PEEK); polyimide; ceramic; Perfluoroalkoxy (PFA) alkane polymers; neoprene; ethylenepropylenediene (EPDM) rubber; Nitrile Butadiene (NBR) rubber; vulcanized gum rubber, such as LINATEX, available from The Weir group PLC; vulcanized natural rubber such as EBONITE, available from Nikko Ebonite Mfg. Co., Ltd.; and/or polyepoxide.

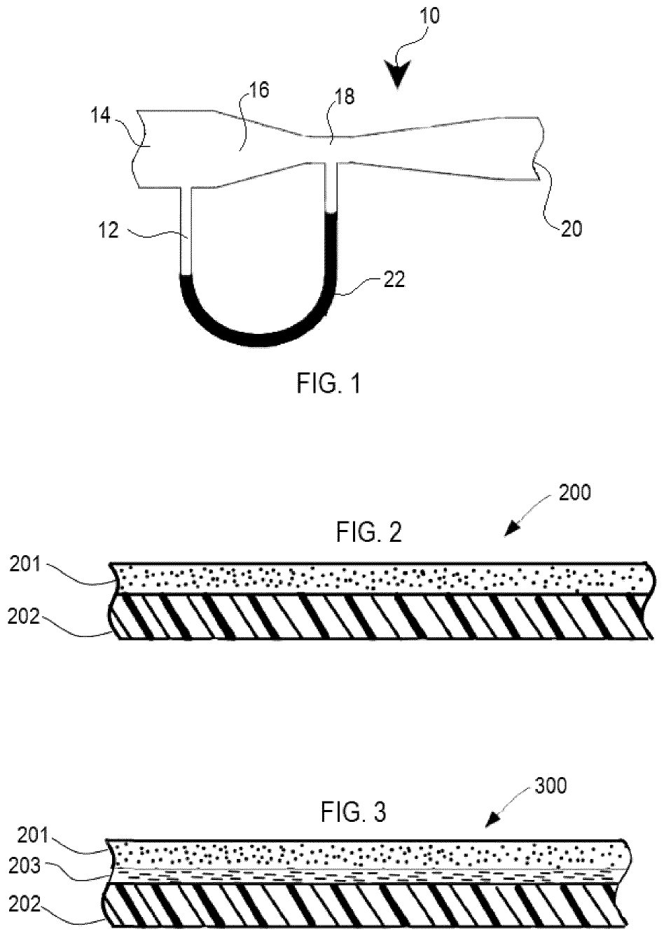

As noted above, the present invention is directed to a treated measurement device 10; a venturi flowmeter is shown as an exemplary measurement device 10 in FIG. 1. The venturi flowmeter comprises numerous components: a fluid inlet 14 through which an aqueous or hydrocarbon fluid enters the measurement device 10, and manometer 12 containing manometer fluid 22. The measurement device 10 further includes a converging inlet nozzle 16, a throat 18, and a diverging outlet 20. The components of the measurement device 10 have an interior surface 202, shown in FIGS. 2 and 3. The surface 202 is made of one or more materials such as those listed above, and may comprise both metal and plastic, such as when the device is lined with a polymeric cladding (e. g., PTFE) and also contains metal sensors.

The components of the measurement device 10 are surface-treated with a fluoropolymer coating layer 201 applied and coupled to the surface 202. For example, the surface 202 may be an interior surface of the converging inlet nozzle 16, the throat 18, and/or the diverging outlet 20.

A schematic cross-sectional view of a portion 200 of a treated measurement device is illustrated in FIG. 2. The fluoropolymer used to form the fluoropolymer coating layer 201 on and couple to surface 202 may comprise a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane. The fluoropolymer coating layer 201 is typically transparent to visible light in a wavelength range of, for example, 200 to 750 nanometers. In certain examples, the fluoropolymer coating layer 201 is transparent to visible light in a wavelength range of 300 to 750 nanometers. In certain examples, the fluoropolymer coating layer 201 is transparent to ultraviolet light in a wavelength range of 200 to 390 nanometers. The fluoropolymer coating layer 201 adheres to both metal and non-metal surfaces.

The fluoropolymer used to form the fluoropolymer coating layer 201 typically comprises at least one of the structures (I) to (XI):

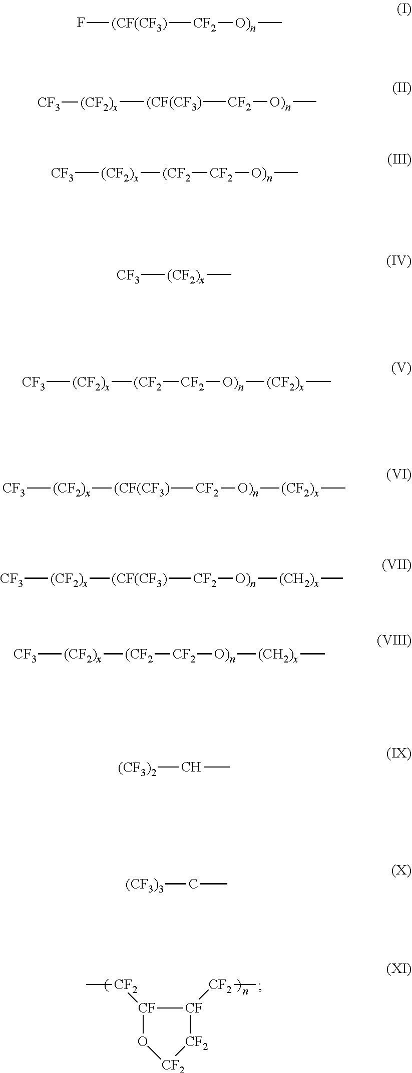

wherein n and x are independently from 1 to 100, or 1 to 75, or 1 to 50, or 1 to 25, or 10 to 100, or 10 to 75, or 10 to 50, or 10 to 25.

For example, the fluoropolymer may comprise a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane with pendant groups comprising one or more of the structures (I) to (XI) above. Structure (XI) is divalent, and may occur, for example, along a backbone of a polyurethane or polyether polymer, or along a pendant or branch group of any of the polymers listed above.

In particular examples, a poly(meth)acrylate or a poly(meth)acrylamide may be formed from one or more of the following starting materials:

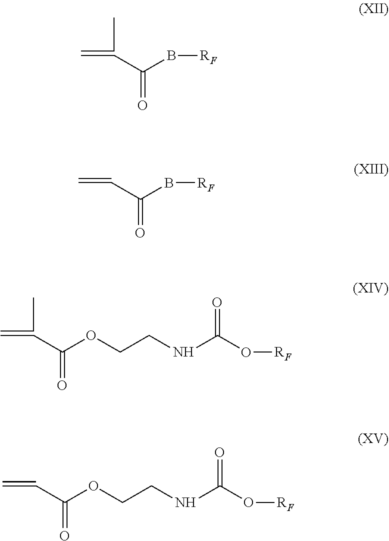

Addition polymers may be formed from the structure:

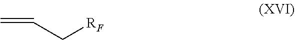

In particular examples, a polysiloxane may have a repeat unit with the following structure:

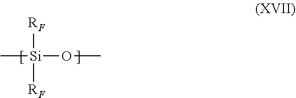

wherein in any of the structures (XII) to (XVII), B is NH or O and R_{F} is as defined above.

The fluoropolymer coating layer 201 typically has a thickness of 100 nm to 3 microns, such as 100 nm to 2 microns, or 200 nm to 900 nm. The layer demonstrates a hexadecane contact angle greater than 50 degrees, thereby reducing deposition of hydrocarbon contaminants on the treated measurement device 10, compared to an untreated device. Hexadecane contact angle may be determined using an optical tensiometer, as known in the art.

In certain examples, the treated measurement device 10 further comprises a self-assembled monolayer 203 coupled to the surface 202 and prepared from a fluorinated material, as shown schematically in FIG. 3. Such a configuration is especially suitable when the surface 202 comprises a metal. The fluoropolymer coating layer 201 is coupled to the surface 202 via the self-assembled monolayer 203, which is between the surface 202 and the fluoropolymer coating layer 201. The self-assembled monolayer 203 is applied to the surface 202 either directly, or alternatively through an intermediate organometallic layer (not shown). The use of a self-assembled monolayer 203 is particularly suitable when the surface 202 comprises a metal. The self-assembled monolayer 203 may be prepared from a fluorinated material in a treatment composition. The fluorinated material may have the following structure (1):

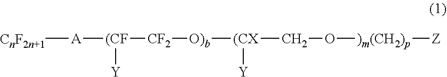

wherein A is an oxygen radical or a chemical bond; n is 1 to 20; Y is H, F, CₙH₂ₙ₊₁ or CnF₂ₙ₊₁; X is H or F; b is at least 1, m is 0 to 50, p is 1 to 20, and Z is an acid group or an acid derivative.

In particular examples of the present invention, n is 1 to 6; b is 5 to 12, m is 1 to 6, and p is 2 to 4. Often, Z is selected from:

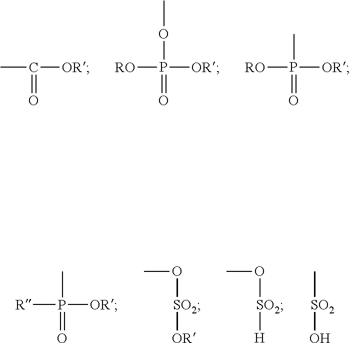

where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons. Typically, Z is

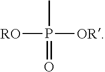

Alternatively, the fluorinated material may comprise any of the moieties defined in structures (I) through (XI) above. For example, the fluorinated material may comprise a phosphonic acid comprising any of the moieties defined in structures (I) through (X) above, such as having one of the following structures:

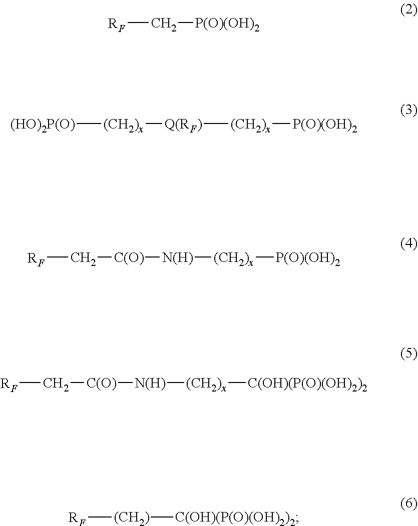

wherein for each of structures (2) through (6), “R_{F}” independently comprises any of structures (I) through (X) as defined above and each x is independently from 1 to 100, or 1 to 75, or 1 to 50, or 1 to 25, or 10 to 100, or 10 to 75, or 10 to 50, or 10 to 25. In structure (3), Q may comprise a divalent linking group bonded to R_{F}; for example, Q may comprise a divalent linear, cyclic or branched alkyl linking group having 1 to 20 carbon atoms, or a divalent aryl linking group having 6 to 20 carbon atoms.

Structure (XI) of R_{F} is divalent as noted above, and may occur in a polyfunctional phosphonic acid compound as a linking group; for example, in a structure such as:

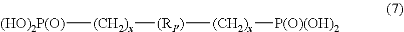

wherein each x is independently from 1 to 100, or 1 to 75, or 1 to 50, or 1 to 25, or 10 to 100, or 10 to 75, or 10 to 50, or 10 to 25.

The treatment composition used to form self-assembled monolayer 203 may further comprise a diluent to form a solution. Suitable diluents include alcohols such as methanol, ethanol or propanol; aliphatic hydrocarbons such as hexane, isooctane and decane, ethers, for example, tetrahydrofuran and dialkylethers such as diethylether. Diluents for fluorinated materials can include perfluorinated compounds such as perfluorinated tetrahydrofuran. Also, aqueous alkaline solutions such as sodium and potassium hydroxide can be used as the diluent. In certain examples of the present invention, the diluent may comprise a slow-drying solvent such as glycols, glycol ethers, and hydrofluoroether solvents. Examples of particular hydrofluoroether solvents include 1,1,1,2,2,3,3,4,4-nonafluoro-4-methoxybutane and/or 1,1,1,2,2,3,3,4,4-nonafluoro-4-ethoxybutane, commercially available from 3M Corporation as NOVEC 7200. Other exemplary solvents include 3-ethoxyperfluoro (2-methylhexane) (HFE 7500, also available from 3M Corporation); 1H,1H,5H-Octafluoropentyl-1,1,2,2-tetrafluoroethyl ether (HFE 6512, available from Fuxin Hengtong); and/or 1,1,1,2,3,4,4,5,5,5-Decafluoropentane (VERTREL XF, available from E. I. DuPont de Nemours). Slower drying solvents provide application latitude and control, and are particularly useful when the treatment composition is to be used in regions with warmer weather, and where climate control is not available.

Adjuvant materials may be present in the treatment composition. Examples include surface active agents, stabilizers, and anti-static agents. The adjuvants if present are present in amounts of up to 30 percent by weight, based on the non-volatile content of the treatment composition.

The concentration of the fluorinated material in the solution is not particularly critical but is at least 0.01 millimolar, typically 0.01 to 100 millimolar, and more typically 0.1 to 50 millimolar. The solution can be prepared by mixing all of the components at the same time or by adding the components in several steps.

The fluoropolymer used to form the fluoropolymer coating layer 201 can be contacted with the surface 202 typically by immersion (which allows for coating both the interior and exterior surfaces), spraying, flow coating, brush application or the like. The fluoropolymer may also be applied by wiping with a cloth. When a treatment composition (to form a self-assembled monolayer 203) is applied first, it may be applied to the surface 202 using any of the methods listed above, followed by evaporating the solution medium at ambient temperatures or by the application of heat to effect formation of the self-assembled monolayer 203. The treatment composition may also be applied by wiping with a cloth. Slower drying solvents in the formulation are particularly useful for wipe application to minimize waste. The fluoropolymer forming fluoropolymer coating layer 201 and treatment composition forming the self-assembled monolayer 203 may also be allowed to flow, sequentially, through the measurement device 10 after the device is in-line (“in situ”). This allows for the treatment of other line components associated with, but not integral to, the device, such as pumps, splicers/couplers, etc.

The self-assembled monolayer 203 formed from the fluorinated material typically is of nano dimensions, having a thickness of no greater than 100 nm, typically about 10-100 nanometers. The monolayer is hydrophobic, having a water contact angle greater than 70°, typically from 75-130°. The water contact angle can be determined using a contact angle goniometer such as a TANTEC contact angle meter Model CAM-MICRO.

The self-assembled monolayer 203 may be adhered to the metal surface 202 either directly, or indirectly through an intermediate organometallic coating (not shown). When better adhesion and durability than that afforded by direct application is desired, an organometallic coating should be applied to the metal surface 202 followed by application of the treatment composition to form the self-assembled monolayer 203.

The organometallic compound used in the intermediate organometallic coating is usually derived from a metal or metalloid, often a transition metal, selected from Group III and Groups IIIB, IVB, VB and VIB of the Periodic Table. Transition metals are used most often, such as those selected from Groups IIIB, IVB, VB and VIB of the Periodic Table. Examples are tantalum, titanium, zirconium, lanthanum, hafnium and tungsten. Niobium is also a suitable metal. The organo portion of the organometallic compound is selected from those groups that are reactive with organophosphorus acid. The organo group of the organometallic compound is also believed to be reactive with groups on the surfaces being treated such as oxide and hydroxyl groups. Examples of suitable organo groups of the organometallic compound are alkoxide groups containing from 1 to 18, usually 2 to 4 carbon atoms, such as ethoxide, propoxide, isopropoxide, butoxide, isobutoxide, tert-butoxide and ethylhexyloxide. Mixed groups such as alkoxide, acetyl acetonate and chloride groups can be used.

The organometallic compounds can be in the form of simple alkoxylates or polymeric forms of the alkoxylate, and various chelates and complexes. For example, in the case of titanium and zirconium, the organometallic compound can include one or more of:
a) alkoxylates of titanium and zirconium having the general formula M(OR)₄, wherein M is selected from Ti and Zr and R is C₁₋₁₈ alkyl,
b) polymeric alkyl titanates and zirconates obtainable by condensation of the alkoxylates of (a), i.e., partially hydrolyzed alkoxylates of the general formula RO[-M(OR)₂O-]ₓ₋₁R, wherein M and R are as above and x is a positive integer,
c) titanium chelates derived from orthotitanic acid and polyfunctional alcohols containing one or more additional hydroxyl, halo, keto, carboxyl or amino groups capable of donating electrons to titanium,
d) titanium acrylates having the general formula Ti(OCOR)₄₋ₙ(OR)ₙ wherein R is C₁₋₁₈ alkyl and n is an integer of from 1 to 3, and polymeric forms thereof, or
e) mixtures thereof.

The organometallic compound can be dissolved or dispersed in a diluent to form a solution. Examples of suitable diluents are alcohols such as methanol, ethanol and propanol, aliphatic hydrocarbons, such as hexane, isooctane and decane, ethers, for example, tetrahydrofuran and dialkyl ethers such as diethyl ether. The concentration of the organometallic compound in the solution is not particularly critical but is usually at least 0.01 millimolar, typically from 0.01 to 100 millimolar, and more typically from 0.1 to 50 millimolar.

Also, adjuvant materials may be present in the solution. Examples include stabilizers such as sterically hindered alcohols, surfactants and anti-static agents. The adjuvants if present are present in amounts of up to 30 percent by weight, based on the non-volatile content of the composition.

The organometallic treatment solution can be prepared by mixing all of the components at the same time or by combining the ingredients in several steps. If the organometallic compound chosen is reactive with moisture, (e.g. in the case of titanium (IV) n-butoxide, tantalum (V) ethoxide, aluminum (III) isopropoxide, etc.), care should be taken that moisture is not introduced with the diluent or adjuvant materials and that mixing is conducted in a substantially anhydrous atmosphere.

The organometallic solution can be contacted with the metal surface 202 typically by immersion, spraying, flow coating, brush application or the like, followed by removing excess solution and evaporating the diluent. This can be accomplished by heating to 50-200° C. or by simple exposure to ambient temperature, that is, from 20-25° C. Alternatively, the organometallic compound can be used neat and applied by vapor deposition techniques.

The resulting film may be in the form of a polymeric metal oxide with unreacted alkoxide and hydroxyl groups. This is accomplished by depositing the film under conditions resulting in hydrolysis and self-condensation of the alkoxide. These reactions result in a polymeric metal oxide coating being formed. The conditions necessary for these reactions to occur is to deposit the film in the presence of water, such as a moisture containing atmosphere; however, these reactions can be performed in solution by the careful addition of water. The resulting film has some unreacted alkoxide groups and/or hydroxyl groups for subsequent reaction and possible covalent bonding with the organophosphorus acid. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

Although not intending to be bound by any theory, it is believed the polymeric metal oxide is of the structure:

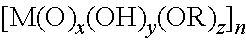

where M is the metal being used, R is an alkyl group containing from 1 to 30 carbon atoms; x+y+z=V, the valence of M; x is at least 1, y is at least 1, z is at least 1; x=V−y−z; y=V−x−z; z=V−x−y; n is greater than 2, such as 2 to 1000.

When the organometallic compound is used neat and applied by chemical vapor deposition techniques in the absence of moisture, a thin metal alkoxide film is believed to form. Polymerization, if any occurs, is minimized and the film may be in monolayer configuration. The resulting film typically has a thickness of 0.5 to 100 nanometers. When the organometallic compound is subjected to hydrolysis and self-condensation conditions as mentioned above, somewhat thicker films are formed.

Although not intending to be bound by any theory, it is believed the phosphonic (or other) acid groups chemically bond with oxide or hydroxyl groups on the metal surface or chemically bond with the hydroxyl or alkoxide group of the organometallic coating, resulting in a durable film. It is believed that the fluorinated material forms a self-assembled monolayer on the surface of the substrate (i. e., the metal surface or organometallic coating layer). Self-assembled layers or films are formed by the chemisorption and spontaneous organization of the material on the surface of the substrate. The fluorinated materials useful in the practice of the invention are amphiphilic molecules that have two functional groups. The first functional group, i.e., the head functional group, is the acid group (typically phosphonic acid) and attaches by physical attraction or by chemical bonding to the surface of the substrate. The second functional group, the fluoro-functional group, i.e., the tail, extends outwardly from the surface of the substrate.

Typically, the fluoropolymer coating layer 201 is adhered to the interior metal surfaces 202 on the components 200, 300 of the measurement device 10, rendering the surfaces of the measurement device components resistant to deposition of hydrocarbon contaminants hereon.

The present invention is further directed to methods of reducing deposition of hydrocarbon contaminants on a surface 202 of a measurement device 10, including any of those devices disclosed above. An exemplary method comprises: (a) contacting the surface 202 with a coating composition comprising a fluoropolymer; (b) forming a fluoropolymer coating layer 201 on the surface 202; and (c) contacting a fluid containing the hydrocarbon contaminants with the fluoropolymer coating layer 201 on the measurement device 10. The fluoropolymer coating layer 201 demonstrates a hexadecane contact angle greater than 50 degrees.

A second exemplary method of reducing deposition of hydrocarbon contaminants on a surface 202, typically a metal surface, of a measurement device 10 comprises: (a) contacting the surface 202 as discussed earlier, either directly or through an intermediate organometallic layer, with a fluorinated material in a diluent. The fluorinated material may comprise any of those discussed above. The method further comprises (b) forming a self-assembled monolayer 203 on the surface 202. Typically, the fluorinated material is dissolved or dispersed in a diluent to form a solution or dispersion (i. e., the treatment composition discussed above), and the solution or dispersion is coalesced on the surface to form the self-assembled monolayer 203. Film formation may be achieved as discussed above. After formation of the self-assembled monolayer 203 on the metal surface 202, the method comprises c) contacting the self-assembled monolayer 203 with a coating composition comprising a fluoropolymer, wherein the fluoropolymer comprises a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane; (d) forming a fluoropolymer coating layer 201 on the self-assembled monolayer 203; and (e) contacting a fluid containing the hydrocarbon contaminants with the fluoropolymer coating layer 201 on the measurement device 10. Again, the fluoropolymer coating layer demonstrates a hexadecane contact angle greater than 50 degrees.

In any of the methods, the fluid may comprise crude oil, brine, or water from an oil or gas reservoir, and the hydrocarbon contaminants may comprise any hydrocarbons known to be contaminants, such as paraffin and/or asphaltenes. The fluoropolymer coating layer 201 on the surface 202 reduces deposition of the hydrocarbon contaminants on the surface 202, decreasing the likelihood of obstructing the measurement device 10.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A treated measurement device comprising:
a) an interior surface; and
b) a fluoropolymer coating layer applied to the interior surface, wherein the fluoropolymer coating layer demonstrates a hexadecane contact angle greater than 50 degrees, thereby reducing deposition of hydrocarbon contaminants on the treated measurement device.

2. The treated measurement device of claim 1, wherein the treated measurement device comprises a Coriolis flow meter, venturi flow meter, magnetic flow meter, ultrasonic flow meter, float sensor, pressure gauge, positive displacement meter, level sensor, system property measurement transmitter, optical window, optical sensor, densitometer, laser-based sensing device, refractometer, viscometer, or a sensor that measures absorbance or transmittance of light.

3. The treated measurement device of claim 1, wherein the interior surface a) comprises stainless steel, austenitic stainless steel, nitinol, nickel-chromium alloy and nickel-chromium-molybdenum alloy, nickel, titanium, tantalum, platinum-iridium alloy, tungsten carbide alloy, zirconium, polytetrafluoroethylene (PTFE), polyether ether ketone (PEEK), polyimide, ceramic, perfluoroalkoxy (PFA) alkane polymers, neoprene, ethylenepropylenediene (EPDM) rubber, nitrile butadiene (NBR) rubber, vulcanized gum rubber, vulcanized natural rubber, and/or polyepoxide.

4. The treated measurement device of claim 1, wherein the fluoropolymer coating layer is transparent to visible light in a wavelength range of 300 to 750 nanometers and/or wherein the fluoropolymer coating layer is transparent to ultraviolet light in a wavelength range of 200 to 390 nanometers.

5. The treated measurement device of claim 1, wherein the fluoropolymer used to form the fluoropolymer coating layer comprises a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane.

6. The treated measurement device of claim 1, wherein the fluoropolymer used to form the fluoropolymer coating layer comprises at least one of the following structures: 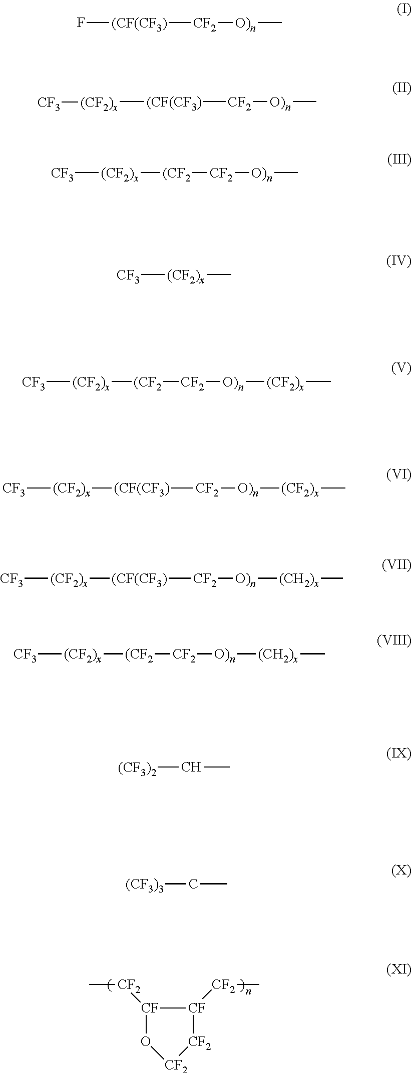
wherein n and x are independently from 1 to 100, or 1 to 75, or 1 to 50, or 1 to 25, or 10 to 100, or 10 to 75, or 10 to 50, or 10 to 25.

7. The treated measurement device of claim 1, wherein the hydrocarbon contaminants comprise paraffin and/or asphaltenes.

8. The treated measurement device of claim 1, further comprising a self-assembled monolayer prepared from a fluorinated material either: (a) having the following structure (1): 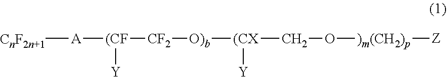
wherein A is an oxygen radical or a chemical bond; n is 1 to 20; Y is H, F, CₙH₂ₙ₊₁ Or CnF₂ₙ₊₁; X is H or F; b is at least 1, m is 0 to 50, p is 1 to 20, and Z is an acid group or an acid derivative; or
(b) comprising a phosphonic acid functional compound, the phosphonic acid functional compound in turn comprising a moiety R_{F}, wherein R_{F} comprises any of the following structures: 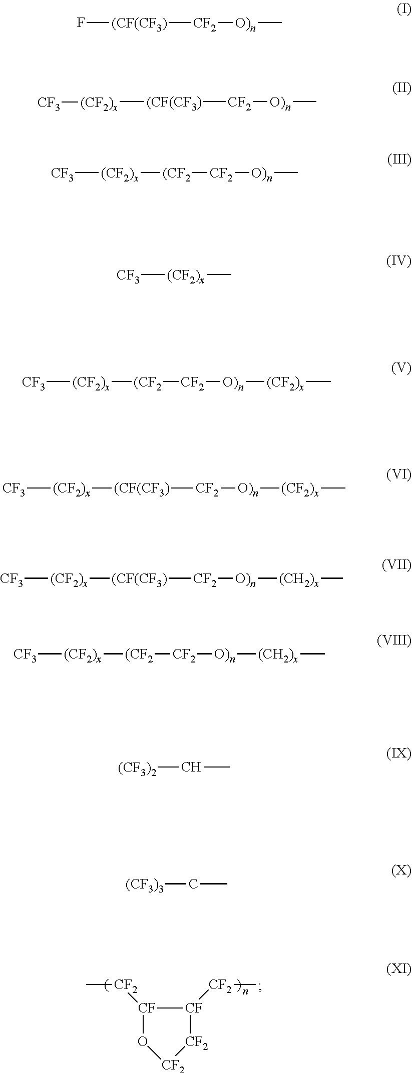
wherein n and x in each of structures (I) through (VIII) and (XI) are independently from 1 to 100, or 1 to 75, or 1 to 50, or 1 to 25, or 10 to 100, or 10 to 75, or 10 to 50, or 10 to 25;
wherein the self-assembled monolayer is between the interior surface a) and the fluoropolymer coating layer b), and is applied to the interior surface a) either directly or through an intermediate organometallic layer.

9. The treated measurement device of claim 8, wherein the fluorinated material comprises structure (1) and Z is selected from: 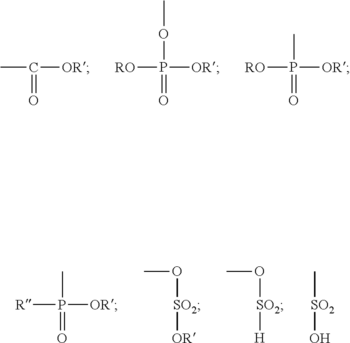
where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons.

10. A method of reducing deposition of hydrocarbon contaminants on a surface of a measurement device, the method comprising:
(a) contacting the surface with a coating composition comprising a fluoropolymer;
(b) forming a fluoropolymer coating layer on the surface; and
(c) contacting a fluid containing the hydrocarbon contaminants with the fluoropolymer coating layer on the measurement device; wherein the fluoropolymer coating layer demonstrates a hexadecane contact angle greater than 50 degrees.

11. The method of claim 10, wherein the measurement device comprises a Coriolis flow meter, venturi flow meter, magnetic flow meter, ultrasonic flow meter, float sensor, pressure gauge, positive displacement meter, level sensor, system property measurement transmitter, optical window, optical sensor, densitometer, laser-based sensing device, refractometer, viscometer, or a sensor that measures absorbance or transmittance of light.

12. The method of claim 10, wherein the surface comprises stainless steel, austenitic stainless steel, nitinol, nickel-chromium alloy and nickel-chromium-molybdenum alloy, nickel, titanium, tantalum, platinum-iridium alloy, tungsten carbide alloy, zirconium, polytetrafluoroethylene (PTFE), polyether ether ketone (PEEK), polyimide, ceramic, perfluoroalkoxy (PFA) alkane polymers, neoprene, ethylenepropylenediene (EPDM) rubber, nitrile butadiene (NBR) rubber, vulcanized gum rubber, vulcanized natural rubber, and/or polyepoxide.

13. The method of claim 10, wherein the fluoropolymer coating layer is transparent to visible light in the range of 300 to 750 nanometers, and/or wherein the fluoropolymer coating layer is transparent to ultraviolet light in the range of 200 to 390 nanometers.

14. The method of claim 10, wherein the fluoropolymer used to form the fluoropolymer coating layer comprises a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane.

15. The method of claim 10, wherein the fluoropolymer used to form the fluoropolymer coating layer comprises at least one of the structures: 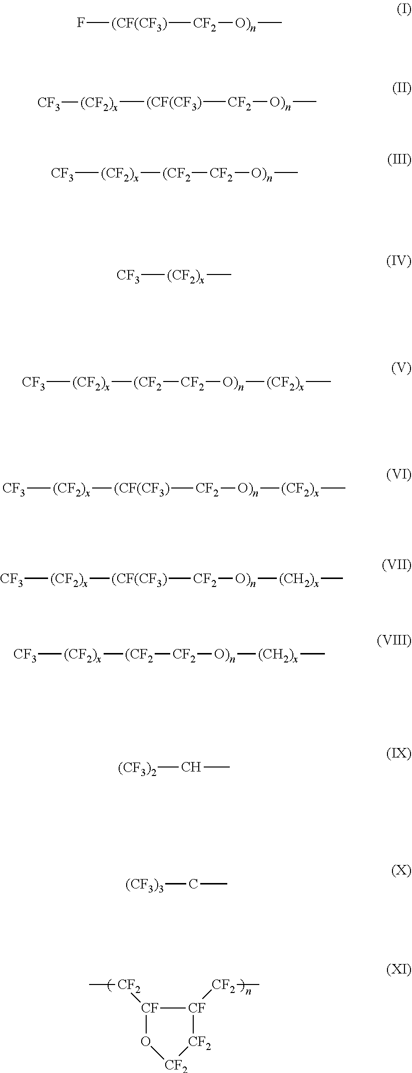
wherein n and x are independently from 1 to 100, or 1 to 75, or 1 to 50, or 1 to 25, or 10 to 100, or 10 to 75, or 10 to 50, or 10 to 25.

16. The method of claim 10, wherein the fluid comprises crude oil, brine, or water from an oil or gas reservoir, and wherein the hydrocarbon contaminants comprise paraffin and/or asphaltenes.

17. A method of reducing deposition of hydrocarbon contaminants on a metal surface of a measurement device, the method comprising:
(a) contacting the metal surface either directly, or through an intermediate organometallic layer, with a fluorinated material in a diluent; wherein the fluorinated material either: (a) has the following structure (1): 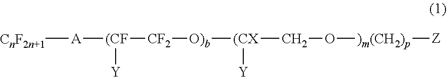
wherein A is an oxygen radical or a chemical bond; n is 1 to 20; Y is H, F, CₙH₂ₙ₊₁ or CnF₂ₙ₊₁; X is H or F; b is at least 1, m is 0 to 50, p is 1 to 20, and Z is an acid group or an acid derivative; or
(b) comprises a phosphonic acid functional compound, the phosphonic acid functional compound in turn comprising a moiety R_{F}, wherein R_{F} comprises any of the following structures: 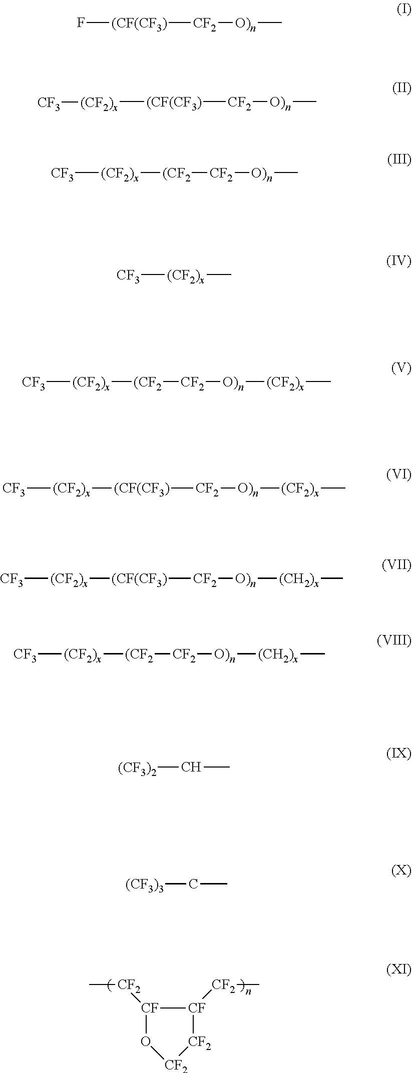
wherein n and x in each of structures (I) through (VIII) and (XI) are independently from 1 to 100, or 1 to 75, or 1 to 50, or 1 to 25, or 10 to 100, or 10 to 75, or 10 to 50, or 10 to 25;
(b) forming a self-assembled monolayer on the metal surface;
(c) contacting the self-assembled monolayer with a coating composition comprising a fluoropolymer, wherein the fluoropolymer comprises a poly(meth)acrylate, a poly(meth)acrylamide, a poly(vinylperfluoroalkyl) polymer, a poly(vinylperfluoroalkyl ether), an amorphous fluoropolymer, a polyurethane, and/or a polysiloxane;
(d) forming a fluoropolymer coating layer on the self-assembled monolayer; and
(e) contacting a fluid containing the hydrocarbon contaminants with the fluoropolymer coating layer on the measurement device; wherein the fluoropolymer coating layer demonstrates a hexadecane contact angle greater than 50 degrees.

18. The method of claim 17, wherein the measurement device comprises a Coriolis flow meter, venturi flow meter, magnetic flow meter, ultrasonic flow meter, float sensor, pressure gauge, positive displacement meter, level sensor, system property measurement transmitter, optical window, optical sensor, densitometer, laser-based sensing device, refractometer, viscometer, or a sensor that measures absorbance or transmittance of light.

19. The method of claim 17, wherein the surface comprises stainless steel, austenitic stainless steel, nitinol, nickel-chromium alloys, nickel-chromium-molybdenum alloys, nickel, titanium, tantalum, platinum-iridium alloy, tungsten carbide alloys, and/or zirconium.

20. The method of claim 17, wherein the fluoropolymer used to form the fluoropolymer coating layer comprises at least one of the structures: 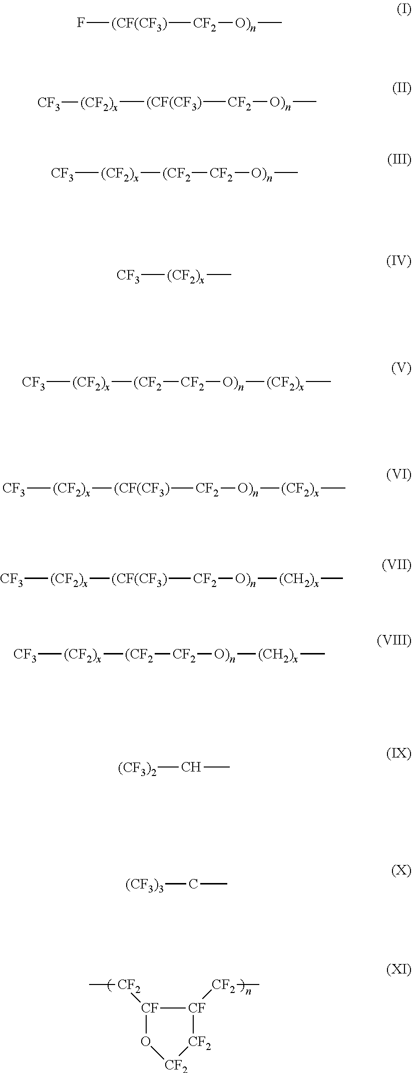
wherein n and x are independently from 1 to 100, or 1 to 75, or 1 to 50, or 1 to 25, or 10 to 100, or 10 to 75, or 10 to 50, or 10 to 25.
